(19) United States
(12) Patent Application Publication
(10) Pub. No.: US 2024/0426001 A1
(43) Pub. Date: Dec. 26, 2024

(54) LARGE-AREA AND FREESTANDING METAL-BASED NANOMEMBRANE ELECTROCATALYST FOR SUSTAINABLE HYDROGEN PRODUCTION

(71) Applicant: City University of Hong Kong, Hong Kong (HK)

(72) Inventors: Yong YANG, Hong Kong (HK); Xiang GAO, Hong Kong (HK); Yun TENG, Hong Kong (HK); Minhyuk PARK, Hong Kong (HK)

(21) Appl. No.: 18/741,839

(22) Filed: Jun. 13, 2024

Related U.S. Application Data
(60) Provisional application No. 63/510,363, filed on Jun. 26, 2023.

(51) Int. Cl. C25B 11/037; B82Y 30/00; B82Y 40/00; C25B 1/04; C25B 11/056; C25B 11/065; C25B 11/081; H01M 8/10; H01M 8/1018

(52) U.S. Cl. CPC C25B 11/037; C25B 1/04; C25B 11/056; C25B 11/065; C25B 11/081; H01M 8/1018; B82Y 30/00; B82Y 40/00; H01M 2008/1095

(57) ABSTRACT

An easy-to-implement method has been developed to create ultrathin Pt nanomembranes, which catalyse the HER at a cost significantly lower than commercial Pt/C and comparable to non-noble metal electrocatalysts. These Pt nanomembranes consist of highly distorted Pt nanocrystals and exhibit a heterogeneous elastic strain field, a characteristic rarely seen in conventional crystals. This unique feature results in significantly higher electrocatalytic efficiency compared to various forms of Pt electrocatalysts, including Pt/C, Pt foils, and numerous Pt single-atom or single-cluster catalysts.

### CROSS-REFERENCE TO RELATED APPLICATIONS

The present application claims the priorities from the U.S. provisional patent application Ser. No. 63/510,363 filed Jun. 26, 2023, and the disclosure of which is incorporated herein by reference in its entirety.

### FIELD OF THE INVENTION

The present invention generally relates to the fields of Materials Science. More particularly, it relates to a highly distorted platinum (Pt) nanomembrane as ultra-efficient yet low-cost catalyst.

### BACKGROUND OF THE INVENTION

In recent years, there has been a growing pursuit of sustainable economies, and electrochemical water electrolysis/splitting has emerged as an attractive method garnering significant attention. This method offers benefits such as fast kinetics and high hydrogen purity. By splitting water molecules into hydrogen and oxygen gases, electrochemical water electrolysis offers an environmentally friendly and renewable approach to hydrogen energy production, reducing reliance on traditional energy sources and mitigating environmental impacts.

However, despite its immense potential, the development of electrochemical water electrolysis has been hindered by a crucial factor-lack of economically efficient and stable catalysts. Catalysts play a vital role in electrochemical water electrolysis. They can lower the energy requirements, enhance reaction rates, and improve product selectivity, thereby enabling more efficient water electrolysis processes. Platinum (Pt) is renowned as one of the best catalysts for the hydrogen evolution reaction (HER) due to its effective binding energy. It exhibits excellent features, including low overpotential and high current density. However, the scarcity and high costs of Pt limit its widespread application.

To date, various synthetic strategies have been developed to maximize the catalytic potential of Pt, such as wet chemical approaches and atomic layer deposition (ALD). For instance, Tiwari et. al¹ synthesed a multicomponent catalyst with an ultralow Pt loading, which was supported on melamine-derived graphitic tubes, following a multi-step process that involved grinding, 750° C. heating, acid leaching, and electrochemical deposition. Liu et. al² fabricated atomically dispersed Pt supported on curved carbon by oxidizing detonation nanodiamonds (DND) powders for 24 hours at 160° C., thermal deoxygenation, 4 hours' oxidation by HNO₃, and finally depositing Pt via ALD. While prior art has demonstrated promising results, these methods typically require high-temperature environments and/or expensive equipment, leading to high energy consumption and costs. Additionally, the yield rate of production is relatively low, underscoring the importance of developing a cost-effective catalyst with a high yield rate for sustainable hydrogen production.

### SUMMARY OF THE INVENTION

Existing catalysts often suffer from high costs, poor stability, and insufficient activity, limiting the practical application and commercialization of electrochemical water electrolysis technologies. Thus, the objective of the present invention is to provide a series of metal-based nanomembrane electrocatalysts, which exhibit highly distorted metal nanocrystals joined together through nanosized amorphous carbon interphases.

In particular, in a first aspect, the present invention provides a large-area and freestanding metal-based nanomembrane electrocatalyst for sustainable hydrogen production, which includes one or more metal nanocrystals with lattice expansion. The one or more metal nanocrystals comprise a highly distorted and heterogeneous nanostructure, and they are joined together through nanosized amorphous carbon interphases. The lattice distortion and heterogeneous strain in the large-area and freestanding metal-based nanomembrane electrocatalyst are induced to achieve enhanced hydrogen evolution reaction performance.

In one embodiment, the large-area and freestanding metal-based nanomembrane demonstrates a heterogeneous distribution of local electric conductivity, characterized by highly conductive nano-domains surrounded by less conductive regions.

In one embodiment, the highly distorted and heterogeneous nanostructure includes FCC nanocrystals and amorphous regions between clusters of FCC nanocrystals.

In one embodiment, the metal is selected from gold, platinum, silver, titanium, palladium, ruthenium, iridium, or other high entropy alloys, or a combination thereof.

In another embodiment, the large-area and freestanding metal-based nanomembrane electrocatalyst includes 20-80 at % of platinum, 10-50 at % of carbon, and 1-30 at % of oxygen.

In one embodiment, the large-area and freestanding metal-based nanomembrane electrocatalyst has a thickness ranging from 1 nm to 30 nm, and the one or more metal nanocrystals have an average size between 1 nm and 10 nm.

In one embodiment, the large-area and freestanding metal-based nanomembrane electrocatalyst is binder-free.

In one embodiment, the large-area and freestanding metal-based nanomembrane electrocatalyst synthesized via polymer surface buckling-enabled exfoliation, including using a polymer layer on a substrate as a scaffold to support a metal film, inducing controlled buckling on the polymer surface, and exfoliating the metal film to obtain the large-area and freestanding metal-based nanomembrane electrocatalyst.

In one embodiment, the substrate comprises glass plate, or silicon wafer. The polymer comprises polyvinyl alcohol.

In one embodiment, the large-area and freestanding metal-based nanomembrane electrocatalyst exhibits an η10 value of less than 30 mV.

Preferably, the large-area and freestanding metal-based nanomembrane electrocatalyst exhibits an η10 value of 26 mV to 29 mV.

In one embodiment, the large-area and freestanding metal-based nanomembrane electrocatalyst exhibits Tafel slopes ranging from 30 mV/dec to 37 mV/dec.

In another aspect, the large-area and freestanding metal-based nanomembrane electrocatalyst has numerous potential applications, particularly as a catalyst. For instance, it can be utilized in water splitting devices. Besides water-splitting devices, the present invention is also applicable to the proton exchange membrane configuration in fuel cells.

The Pt nanomembrane of the present invention offers the following advantages: (1) Outstanding HER performance; (2) a promising approach for developing highly efficient and cost-effective low-dimensional electrocatalysts; (3) easy fabrication; (4) good stability; and (5) binder-free.

### BRIEF DESCRIPTION OF THE DRAWINGS

Embodiments of the invention are described in more details hereinafter with reference to the drawings, in which:

FIG. 1 shows a schematic diagram of a water splitting device according to one embodiment of the present invention;

FIG. 2 depicts Pt loading content of nanomembrane with different depth measured by Inductively Coupled Plasma Optical Emission spectroscopy (ICP-OES);

FIG. 3A shows a photograph of the 19-nm-thick freestanding Pt nanomembranes on water surface. FIG. 3B shows height profile images of transferred Pt nanomembranes (thickness of 5 nm, 10 nm, 19 nm and 28 nm) on silicon; the insets show the AFM images across the edge of the Pt nanomembrane. FIG. 3C depicts X-ray diffraction pattern of 19 nm Pt nanomembrane. FIG. 3D shows conductive atomic force microscopy (C-AFM) mapping image of 19 nm nanomembrane, and right side shows the enlarged view. FIG. 3E shows a low-magnification TEM image of the 19-nm-thick freestanding Pt nanomembrane, inset shows the corresponding SADP. FIG. 3F depicts radially integrated intensity of the diffraction patterns of the freestanding nanomembrane, in comparison with those of the single-phase FCC bulk Pt as indicated by the dash lines. FIG. 3G shows HAADF-STEM images from the [011] direction of a typical platinum NP with the FCC structure. FIG. 3H shows a high-revolution TEM image of the 19-nm-thick Pt nanomembrane. Insets are fast Fourier transform (FFT) patterns of the amorphous (upper right) and crystalline (lower left) regions. FIG. 3I shows high-angle annular dark-field scanning transmission electron microscopy (HAADF-STEM) images of a typical Pt NC with a FCC structure and corresponding elements maps of Pt, C, and O. FIG. 3J depicts lattice constant with the size of Pt nanocrystal (NC);

FIG. 4A shows inverse fast Fourier transformation (IFFT) analysis of the high-resolution TEM image of a typical Pt NC with a FCC structure in FIG. 3H. FIG. 4B shows contour map of the normal stain εₓₓ in FIG. 4A. FIG. 4C shows distribution of the strain εₓₓ component;

FIG. 5A shows low magnification of TEM image of 5 nm Pt nanomembrane. FIG. 5B shows enlarged TEM image showing Pt nanoparticle and amorphous carbon, and the corresponding FFT images. FIG. 5C shows HAADF-STEM image and corresponding elements maps of Pt, C and O. FIG. 5D shows high resolution TEM image showing the defects of vacancy in the orientation of [001]. FIG. 5E depicts line scan of intensity showing the location of Pt vacancy;

FIG. 6A depicts X-ray photoelectron spectroscopy (XPS) depth profile analysis of Pt nanomembrane. Narrow-scan XPS spectra for Pt 4f, C 1s, and O Is as a function of etching time. FIG. 6B depicts relative atomic concentration of Pt, C, and O with etching time, as obtained from the quantitative analysis of the XPS. FIG. 6C depicts X-ray absorption near edge structure (XANES) at Pt L₃ edge. FIG. 6D depicts FT-EXAFS region for the local structure of Pt. FIG. 6E depicts FT-EXAFS spectra in r-space and the corresponding least-squares fit for the first shell of Pt foil and 19 nm Pt nanomembrane. FIG. 6F depicts EXAFS χ(k) signals in k-space and the corresponding least-squares fit for Pt foil and 19 nm Pt nanomembrane. FIG. 6G depicts EXAFS χ(k) signals in k-space. FIG. 6H shows the wavelet transform for the k3-weighted EXAFS Pt K-edge signal of Pt foil and Pt nanomembrane, respectively;

FIG. 7A shows SEM images of pure carbon clothes, 5 nm, 10 nm, 19 nm, 28 nm nanomembranes transferred to carbon clothes. FIG. 7B shows line scan of carbon clothes with 19 nm nanomembrane. FIG. 7C shows energy dispersive spectroscopy (EDS) mapping of carbon clothes with 19 nm nanomembrane. FIG. 7D depicts LSV curves of 5 nm, 10 nm, 19 nm, 28 nm nanomembrane and bulk Pt sheet. FIG. 7E depicts Tafel slopes of 5 nm, 10 nm, 19 nm, 28 nm nanomembrane and bulk Pt sheet;

FIG. 8A depicts EIS plots of 5 nm, 10 nm, 19 nm, 28 nm nanomembrane and bulk Pt sheet. FIG. 8B depicts cyclic voltammetry (CV) curves of 5 nm, 10 nm, 19 nm, 28 nm and Pt foil at a scan rate of 50 mV/s;

FIG. 9 depicts mass activity comparison for Pt sheet, Pt nanomembrane with commercial Pt/C at the potential 50 mV;

FIG. 10A depicts stability tests of different thick Pt nanomembranes (5 nm, 10 nm, 19 nm, and 28 nm) at the current density of 10 mA cm⁻². FIG. 10B depicts a comparison of overpotential at 10 mA/cm² and Tafel slope with many other recently reported HER electrocatalysts;

FIG. 11 shows SEM images of 19 nm Pt nanomembrane transferred to carbon clothes after 24 hours 10 mA/cm² stability, and EDS mapping of carbon clothes with 19 nm nanomembrane after stability tests;

FIG. 12 shows proton exchange membrane water electrolyzer (PEM-WE) device performance using the 19 nm Pt nanomembrane as the cathodic HER catalyst and commercial IrO₂ as the anodic OER catalyst at room temperature, insets are the schematic (left) and photograph (right) of the PEM-WE;

FIG. 13A shows the experimental force-displacement curve of a 19 nm-thick Pt nanomembrane under AFM indentation in comparison with the FEA simulations.

FIG. 13B shows AFM scanning images of the suspended Pt nanomembrane before and after indentation.

FIG. 13C shows comparison of the yield strength and ductility of Pt nanomembrane with those of nanocrystalline (NC) and polycrystalline (PC) Pt films, bulk Pt and Pt nanowires (NWs).

FIG. 13D shows comparison of Young's modulus of Pt nanomembrane, Pt nanoparticle (NP) and bulk Pt;

FIG. 14A shows atomic configurations of Pt nanocrystalline with substitutional C atoms, and distribution of local shear strain which reflected by color coding. FIG. 14B shows distribution of Shear Strain, Volumetric Strain via Pt nanocrystalline with/without surface atoms, respectively;

FIG. 15 shows projected density of states (DOS) on pristine Pt and distorted Pt surface at crystal orientation (111), (110), and (100), respectively, the dot line indicates Fermi level;

FIG. 16A shows adsorption free energy versus the reaction coordinate of HER for a conventional crystal with the uniform tensile strain ranging from 0 to 7%, and adsorption free energy versus the reaction coordinate of HER for a distorted crystal with the heterogeneous tensile strain of 0-7%. FIG. 16B shows comparison of free energy vs strain between a conventional and a distorted crystal with the orientation of (111), (110), and (100), insets are the strain mappings of a distorted crystal and conventional crystal at the orientation (111). FIG. 16C shows adsorption free energy versus the reaction coordinate of HER for a distorted crystal with 2 vacancies, with the heterogeneous tensile strain ranging from 0 to 7%, and adsorption free energy versus the reaction coordinate of HER for a distorted crystal with 3 vacancies, with the heterogeneous tensile strain of 0-7%; FIG. 16D shows simulation of substitutional defects C or O, and adsorption free energy of a non-distorted Pt nanocrystal; and

FIG. 17 shows comparison of overpotential at 10 mA/cm² and cost per area with pure Pt foil.

### DETAILED DESCRIPTION

The widespread adoption of efficient electrocatalysts, such as Platinum (Pt), has been hindered by their high cost. Traditional Pt catalysts are typically used in powdered form, which presents challenges due to their limited surface area, resource availability, and high cost. Therefore, developing an efficient and cost-effective Pt catalysts and their preparation processes are of paramount significance.

Accordingly, the present invention provides a large-area and freestanding metal-based nanomembrane electrocatalyst for sustainable hydrogen production, which includes one or more metal nanocrystals with lattice expansion. The one or more metal nanocrystals comprise a highly distorted and heterogeneous nanostructure, and they are joined together through nanosized amorphous carbon interphases. The lattice distortion and heterogeneous strain in the large-area and freestanding metal-based nanomembrane electrocatalyst are induced to achieve enhanced hydrogen evolution reaction performance.

Notably, the large-area and freestanding metal-based nanomembrane demonstrates a heterogeneous distribution of local electric conductivity, characterized by highly conductive nano-domains surrounded by less conductive regions. The highly distorted and heterogeneous nanostructure may be FCC nanocrystals and amorphous regions between clusters of FCC nanocrystals.

In one embodiment, the metal may include gold, platinum, silver, titanium, palladium, ruthenium, iridium, or other high entropy alloys, or a combination thereof.

Preferably, the metal is platinum (Pt). The prepared Pt nanomembrane exhibits outstanding HER, superior to the benchmark catalyst commercial Pt foil. More importantly, the cost of Pt nanomembrane is extremely low comparable to non-noble metals, which results from the ultra-thin depth and clustering of individual Pt Nanoparticles within amorphous carbon.

Preferably, the large-area and freestanding metal-based nanomembrane electrocatalyst may include 20-80 at % of platinum, 10-50 at % of carbon, and 1-30 at % of oxygen.

The large-area, freestanding 2D Pt nanomembrane is fabricated by using a polymer surface buckling-enabled exfoliation (PSBEE) method³⁻⁵. The nanomembrane exhibits outstanding HER performance with a small overpotential, good stability, and high turnover frequency (TOF), superior to the benchmark catalyst commercial Pt foil.

The polymer surface buckling-enabled exfoliation includes the following steps:
(1) using a polymer layer on a substrate as a scaffold to support a metal film;
(2) inducing controlled buckling on the polymer surface; and
(3) exfoliating the metal film to obtain the large-area and freestanding metal-based nanomembrane electrocatalyst.

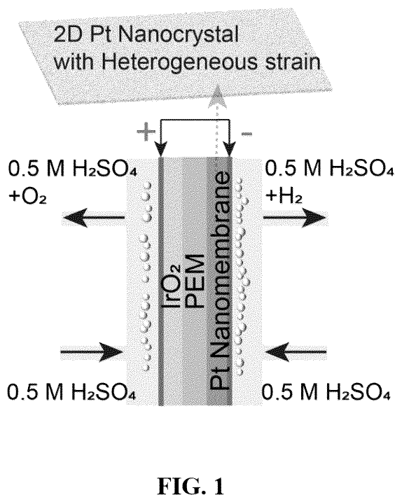

PSBEE method offers a low-cost, high yield and easily implemented method. Its simplicity coupled with the ultra-thin thickness of the nanomembranes, reduces both production and material costs, making the 2D Pt catalyst of the present invention even more cost effective than Pt foil (FIG. 1). These 2D Pt nanomembranes provide insights into a new mechanism for an efficient catalyst design strategy: lattice distortion-induced heterogeneous strain.

In one embodiment, the large-area and freestanding metal-based nanomembrane electrocatalyst is binder-free.

In one embodiment, the large-area and freestanding metal-based nanomembrane electrocatalyst has a thickness ranging from 1 nm to 30 nm. The one or more metal nanocrystals have an average size between 1 nm and 10 nm.

In one embodiment, the metal nanomembrane has a depth in a range of 1 nm to 100 nm.

Preferably, the metal nanomembrane has a depth in a range of 5 nm to 76 nm.

In another embodiment, the metal nanomembrane has metal nanocrystals with a size between 1 nm to 10 nm.

Preferably, the metal nanomembrane has platinum nanocrystals with a size between 3 nm to 7 nm.

In one embodiment, the large-area and freestanding metal-based nanomembrane electrocatalyst exhibits an η10 value of less than 30 mV, less than 25 mV, or less than 20 mV.

In one embodiment, the large-area and freestanding metal-based nanomembrane electrocatalyst exhibits Tafel slopes ranging from 30 mV/dec to 37 mV/dec.

### EXAMPLE

### Example 1-Materials and Methods

### Electronic Property Characterization

Atomic force microscopy (AFM, MFP-3D Origin, Oxford Instruments), X-ray photoelectron spectroscopy (XPS), and transmission electron microscopy (TEM) were used to characterize and measure the structural and chemical properties of the metal nanomembranes.

For example, the freestanding Pt nanomembranes were transferred onto various substrates, such as Si wafers and TEM grids. The thickness and surface topography of the as-prepared Pt nanomembranes on Si wafers were then examined using AFM, and those on grids using conventional field emission TEM (JEM-2100, JEOL) at an acceleration voltage of 200 kV and Cs-corrected thermal field emission TEM (ARM200F, JEM) at 300 kV. Agilent 720ES (OES) was used to determine the content of Pt loading for different thicknesses and the Pt ion concentration after stability tests.

Data reduction, analysis, and EXAFS fitting were performed using the Athena and Artemis programs of the Demeter data analysis packages. These programs utilize the FEFF6 program to fit the EXAFS data. Energy calibration for the sample was conducted using a standard Pt foil as a reference, which was measured simultaneously. A linear function was subtracted from the pre-edge region, and the edge jump was normalized using Athena software. The χ(k) data was isolated by subtracting a smooth, third-order polynomial approximating the absorption background of an isolated atom. The k3-weighted χ(k) data were Fourier transformed after applying a Hanning window function (Δk=1.0). For EXAFS modeling, global amplitude EXAFS (CN, R, σ², and ΔE₀) was obtained through nonlinear fitting and least-squares refinement of the EXAFS equation to the Fourier-transformed data in R-space, using Artemis software. The EXAFS of the Pt foil was fitted and the obtained amplitude reduction factor S₀² value (0.839) was set in the EXAFS analysis to determine the coordination numbers (CNs) in the Pt—C/O/Pt scattering path in the sample.

### Mechanical Characterization

The mechanical properties of the prepared Pt nanomembranes were characterized using AFM-based indentation. The freestanding Pt nanomembranes were transferred onto patterned Si wafers and suspended over the holes. A diamond-coated silicon tip (NC-LC, Adama) was used with a 30 nm tip radius to perform indentation measurements at a rate of 300 nm/s. Pt nanomembranes with thicknesses of 19 nm and 28 nm were tested under ambient conditions, with each group consisting of 15 nanomembranes. Young's modulus, yield strength, and ductility of the Pt nanomembranes were derived from these data sets. They were extracted from finite element analysis (FEA) performed using the commercial software ANSYS (ANSYS Inc., USA). In the theoretical model, the suspended nanomembranes in actual experiments were modeled as axisymmetric membranes with a radius of 1-2 μm. A rigid, frictionless sphere with a radius of 30 nm was used to replace the AFM tip in the model. The Poisson's ratio of nanomembranes was taken as 0.35, based on platinum. Young's modulus and yield strength were then determined by tracing back using elastic and elastoplastic constitutive equations. Additionally, the ductility of Pt nanomembranes was determined as the maximum von Mises strain developed just before strain softening.

### Electrochemical Measurements

In a typical test, the freestanding 2D Pt nanomembrane was transferred to any substrate. After peeling off from PVA substrates, the Pt nanomembranes floated on the water surface. The carbon clothe was then immersed beneath the water and selectively “scooped out” the desired number of Pt nanomembranes. Using this approach, controlled loading of Pt nanomembranes onto the commercial carbon cloth was successfully achieved, followed by drying at room temperature. All measurements were performed at room temperature in a standard three-electrode system using an H₂-saturated 0.5 M H₂SO₄ electrolyte. A carbon rod (diameter=6 mm) was used as the counter electrode and a saturated calomel electrode (SCE) was used as the reference electrode. The saturated calomel electrode (SCE) was calibrated to the reversible hydrogen electrode (RHE) under H₂-saturated electrolyte with Pt foils serving as both the working electrode and counter electrode, as follows:

$${E}_{RHE} = {E}_{SCE} - 0.27 V$$

Electrochemical impedance spectroscopy measurements were conducted at an overpotential of 10 mV vs RHE with a 10 mV AC potential, ranging from 10⁵ Hz to 0.01 Hz. Additionally, the time-dependent potential curve was collected by maintaining the current density at 10 mA/cm² for 24 hours.

### TOF and Active-Site Density Calculations

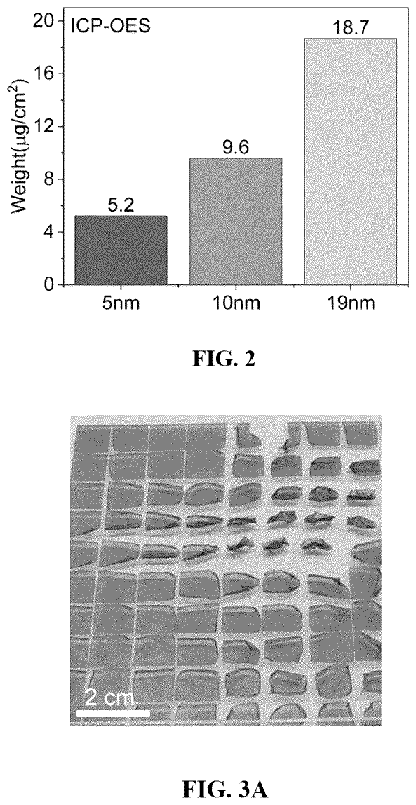

The total number of hydrogen turnovers was calculated from the current density using the formula:

$$TOF = \frac{Total number of hydrogen turnover / geometric area ( {cm}^{2} )}{Number of active site / geometric area ( {cm}^{2} )}$$

$$\begin{matrix}The number of hydrogen = j ( \frac{mA}{{cm}^{2}} ) 1 ( {{Cs}^{- 1} ( {10}^{3} mA )}^{- 1} ) \\ ( 1 mole {{e}^{-} ( 96485.3 C )}^{- 1} ) \times \\ \frac{1 mole {H}_{2}}{2 mole {e}^{-}} \frac{6.022 \times {10}^{23} molecules {H}_{2}}{1 mole {H}_{2}} \\ = 3.12 \times {10}^{15} {H}_{2} {s}^{- 1} {cm}^{- 2} per mA / {cm}^{2}\end{matrix}$$

where the Pt loading L was determined from the Inductively Coupled Plasma Optical Emission spectroscopy (ICP-OES) measurement (FIG. 2). Thus, the active site density on bulk Pt was:

$$L \times \frac{1 mmol}{195.1 mg} \times 6.022 \times {10}^{20}$$

In the present invention, TOF was at the potential of 100 mV with the current density for the 5 nm, 10 nm and 19 nm thick nanomembranes being 74.7 mA/cm², 83.8 mA/cm² and 89.7 mA/cm² respectively:

$${TOF}_{5 nm} = \frac{3.12 \times {10}^{15} \times {H}_{2} s {cm}^{2} \times 74.7 mA / {cm}^{2}}{1.6 \times {10}^{15}} = 145.7 {s}^{- 1} per Pt - site$$

$${TOF}_{10 nm} = \frac{3.12 \times {10}^{15} \times {H}_{2} s {cm}^{2} \times 83.8 mA / {cm}^{2}}{2.9 \times {10}^{15}} = 90.2 {s}^{- 1} per Pt - site$$

$${TOF}_{19 nm} = \frac{3.12 \times {10}^{15} \times {H}_{2} s {cm}^{2} \times 89.7 mA / {cm}^{2}}{5.8 \times {10}^{15}} = 48.3 {s}^{- 1} per Pt - site$$

### Theoretic Calculations

The first-principles total energy calculations were performed using the Vienna Ab initio Simulation Package (VASP) and the projector augmented wave (PAW) method. A plane wave cutoff energy of 400 eV was employed. Convergence criteria for energy and force were set at 10⁻⁵ CV and 0.02 cV/Å², respectively. A 4×4 supercell containing eight atomic layers was constructed to simulate models I and II of Pt (111), (110) and (100) incorporating a vacuum layer larger than 15.0 Å along the z-axis to prevent periodic interaction. Tensile strain ranging from 0% to 7% was applied along the x-axis, which increased the elastic strain in the unit cell correspondingly. In this unit slab cell, vacancy concentrations were incremented by 6.25% (up to 18.75%), with vacancy concentration defined as the total number of vacancies divided by the total number of atoms in the pristine basal plan.

The Gibbs free energy of H adsorption (ΔG_{H*}), a widely used descriptor for correlating theoretical predictions with experimental measurements of catalytic activity for various systems, was calculated using the following equation:

$$Δ {G}_{{H}^{*}} = Δ {E}_{{H}^{*}} + Δ {E}_{ZPE} - T Δ S$$

where ΔE_{H*} denoted the hydrogen adsorption energy, ΔE_{ZPE} represented the zero-point energy correction term, T was the temperature (298.15 K) and ΔS represented the entropy difference.

Optimal catalytic activity was indicated by a ΔG_{H*} value close to zero, while very negative or positive values signified overly strong or weak adsorption, respectively.

The large-scale atomic/molecular massively parallel simulator (LAMMPS) package was utilized to perform MD simulations. These simulations utilized an empirical force field described by a modified embedded-atom method (MEAM) potential for the Pt—C system. To observe the lattice distortion effect, approximately 20% of C atoms were introduced as substantial defects in Pt nanocrystals, which had a nanograin size of approximately 10 nm. The atomic configurations were visualized using the OVITO software.

### Example 2

### Fabrication of Pt Nanomembrane

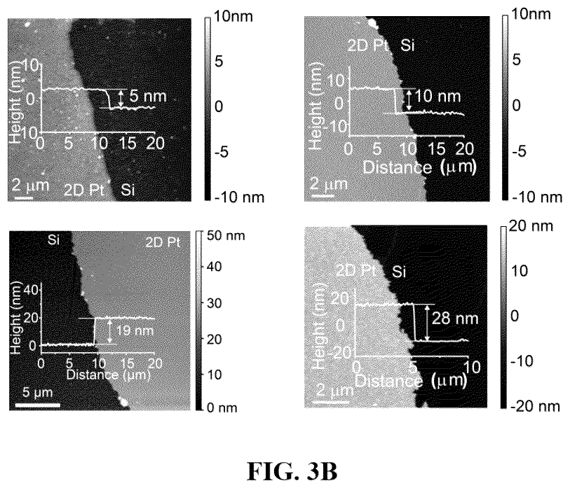

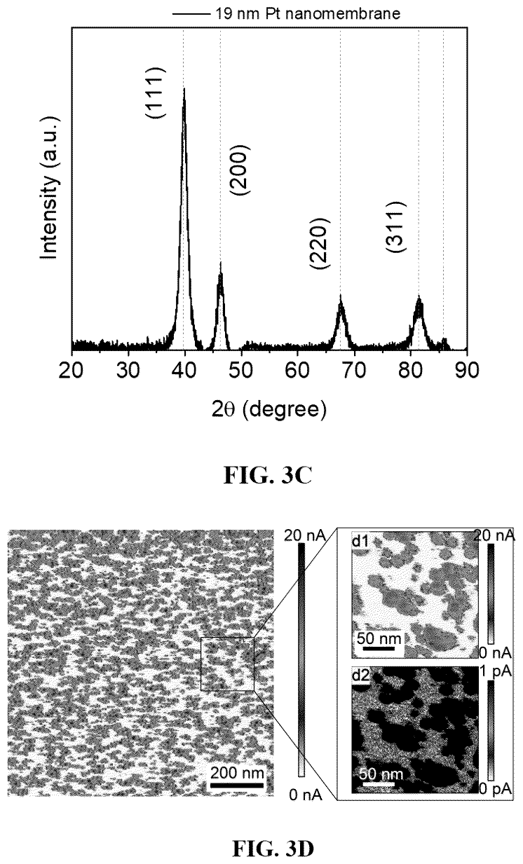

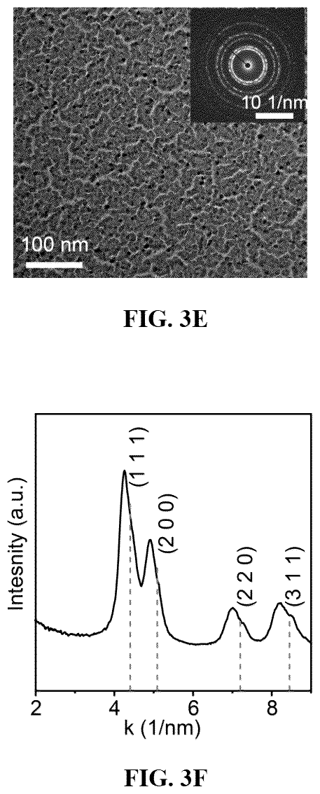

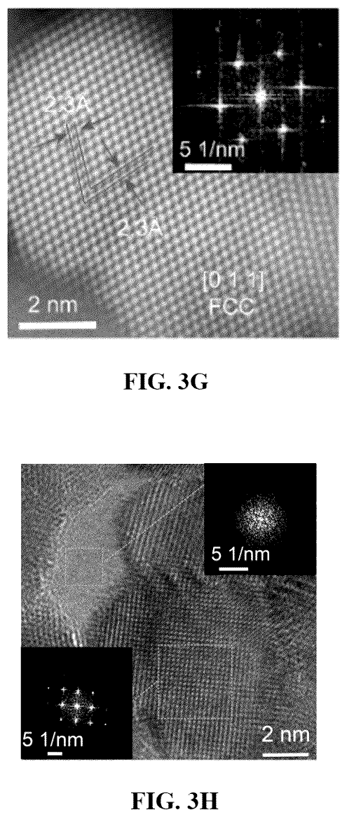

The large area, freestanding 2D Pt nanomembranes with thicknesses ranging from 5 nm to 28 nm were fabricated by using a polymer surface buckling-enabled exfoliation (PSBEE) method (FIG. 3A). In one embodiment, a polyvinyl alcohol (PVA) hydrogel layer onto a glass plate was used as a scaffold to support the thin Pt film. The Pt film was deposited on top of the PVA layer using ion beam sputtering. By inducing controlled buckling on the polymer surface, the thin Pt film was exfoliated. Afterward, the Pt-PVA-glass system was immersed in deionized (DI) water. After several minutes, the freestanding nanosheets spontaneously peeled off from the PVA substrate, resulting in the formation of large area, freestanding Pt nanomembranes.

In another embodiment, the glass plate could be replaced by other suitable substrates once it was smooth could be spinning coated with polyvinyl alcohol hydrogel. For example, silicon wafer was a suitable substrate.

### Example 3

### Characterization of the Pt Nanomembrane

Referring to FIG. 3B, which showed the transmission electron microscopy (TEM) images of the Pt nanomembranes. The thicknesses of these 2D Pt could be easily varied from 5 nm to 28 nm, whilst the in-plane size remains at approximately 1 cm. Referring to FIG. 3C, the XRD results demonstrated that the diffraction peaks align with those of bulk FCC Pt and exhibit considerable broadening. The interpretation of peak broadening in metal XRD spectra encompassed various factors, such as lattice strain, dislocations, and grain boundaries. Direct observations using TEM still remain a reliable method to characterize lattice distortion in metals.

Referring to FIG. 3D, the conductive AFM (C-AFM) scanning could infer that the Pt nanomembrane of the present invention demonstrated a heterogeneous distribution of local electric conductivity, with highly conductive nano-domains surrounded by less conductive ones. The heterogeneous nanostructure was aligned to FCC atomic packing as revealed in the corresponding selected-area diffraction pattern (SADP) (inset) (FIG. 3E). Such conductivity distribution manifests the heterogeneous nanostructure of the Pt nanomembranes.

Referring to FIG. 3F, utilizing the 2D SADP and integrating it with respect to the diffraction angle, a series of 1D diffraction peaks were successfully computed. These peaks aligned with a typical FCC diffraction pattern, except for a noticeable shift to lower wave numbers. This shift indicated that there was an overall tensile strain presented in the FCC lattices within the Pt nanomembranes. FIG. 3G displayed scanning transmission electron microscopy (STEM) of the Pt nanomembranes, revealing the presence of FCC nanocrystals (NC). FIG. 3H displayed high-resolution TEM (HRTEM) of the Pt nanomembranes, revealing the presence of amorphous regions between clusters of FCC nanocrystals (NC). STEM-EDS analysis in FIG. 3I showed that the FCC NCs primarily contained Pt with C and O elements. Through extensive quantitative measurements, it could observe that the size of the Pt NCs ranged from 3 to 7 nm, with significant lattice expansion compared to bulk Pt (FIG. 3J).

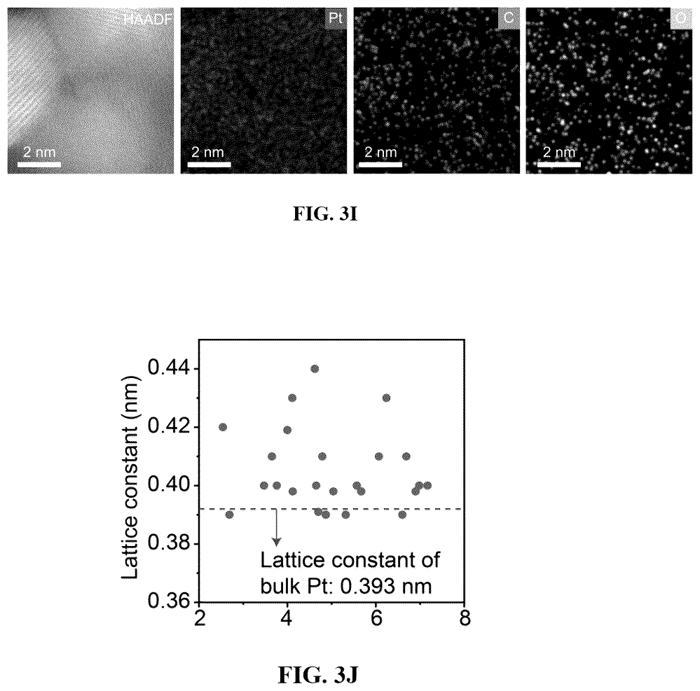

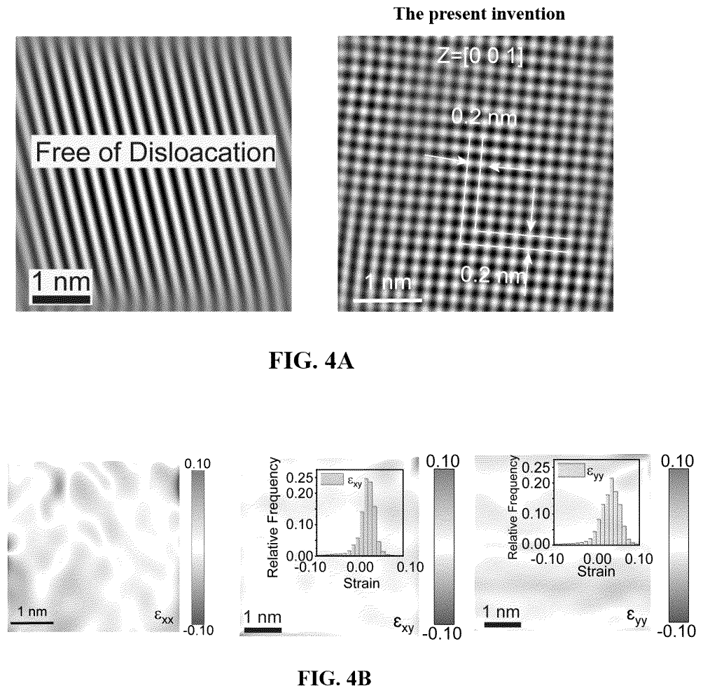

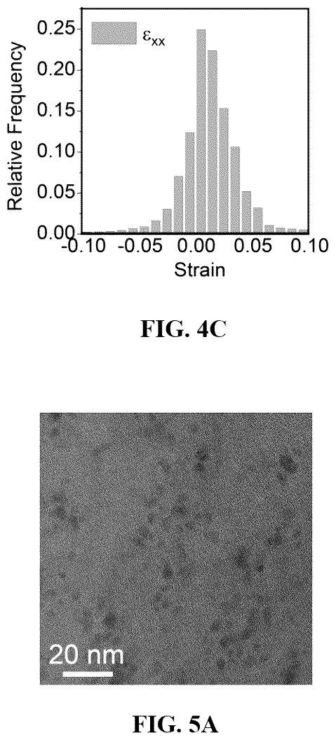

By utilizing Geometric Phase Analysis (GPA), it was able to map out the lattice strains component distribution in the Pt NCs that were free of crystalline defects, such as dislocations, as shown in FIGS. 4A-4C. Evidently, the lattice strain field within the Pt NCs was heterogeneous, consisting of both shear and normal components.

Notably, the averaged normal strains are positive or tensile, consistent with the average lattice strain obtained by measuring lattice constants (FIGS. 3F and 3J). Creating metal-based nanomembranes via PSBEE (e.g., gold or high entropy alloy) can be regarded as assemblies of metal-based NCs during metal deposition and exfoliation. Similarly, the present Pt nanomembranes displayed a heterogeneous nanostructure that features NC assembly and percolation.

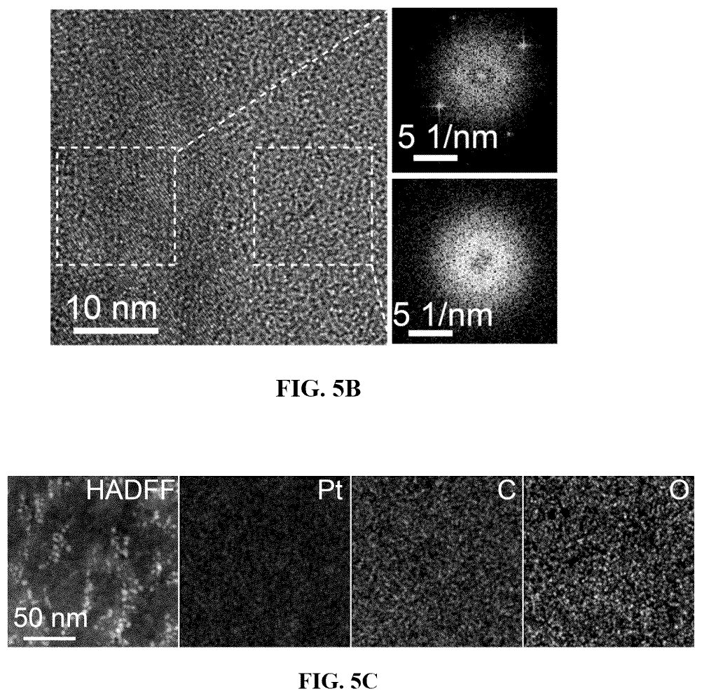

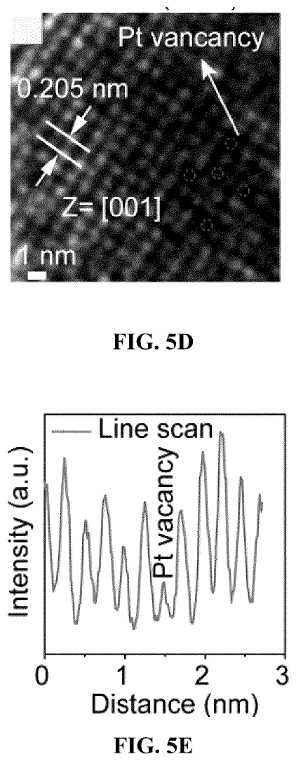

Referring to FIGS. 5A-5C, the TEM analysis of the 5 nm Pt nanomembrane revealed the presence of amorphous carbon and dispersed Pt nanoparticles. Because of the gradual transition from amorphous carbon to crystalline Pt, significant lattice distortion was anticipated, especially in the near-interface region. However, quantitatively characterizing the strain was challenging due to signal mixing from both the amorphous and crystalline regions. When the nanomembrane thickness increased to 10 nm, the nanoparticles percolated to form a network structure. These strains were similar to those obtained for the 19 nm and 28 nm Pt nanomembranes. Additionally, a notable presence of vacancies in the Pt nanomembrane was observed (FIGS. 5D-5E).

### Example 4

### Electronic Property of Pt Nanomembrane

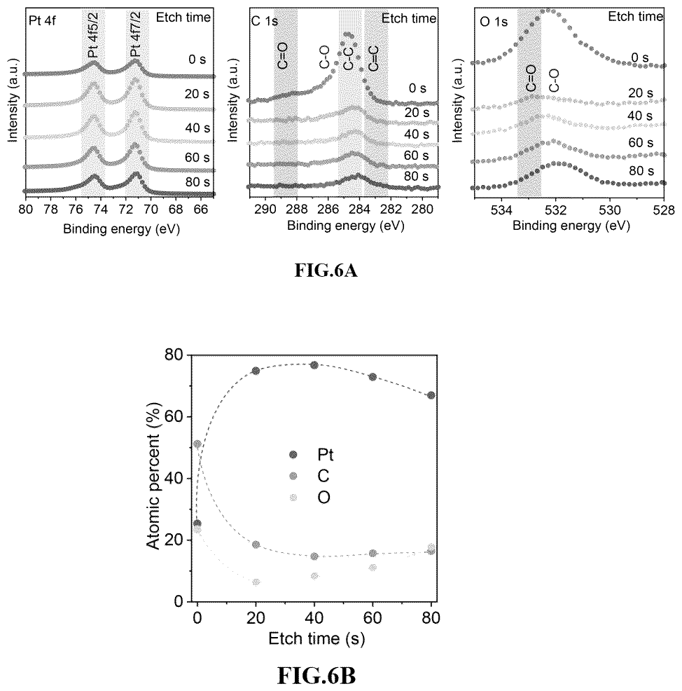

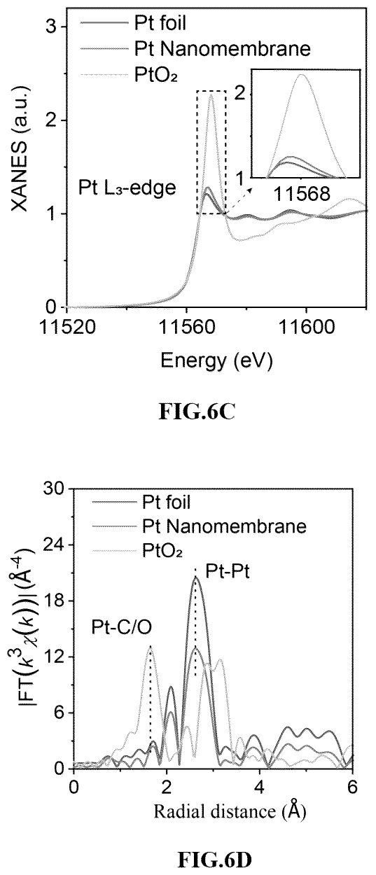

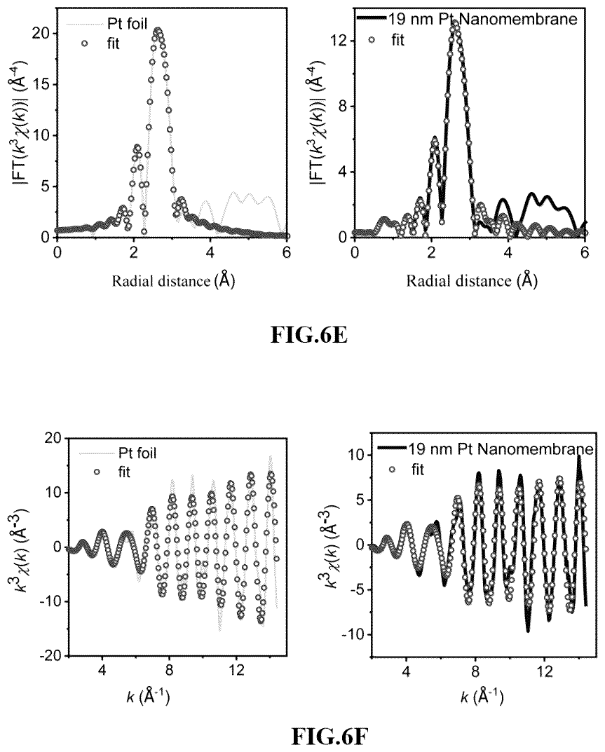

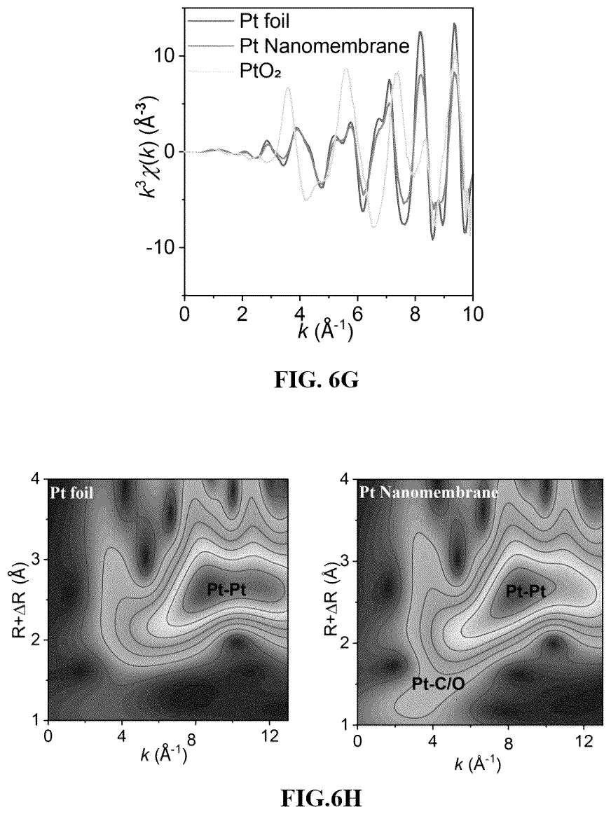

To further characterize the chemistry of the Pt nanomembranes, X-ray photoelectron spectroscopy (XPS) was conducted, as shown in FIG. 6A. The observed XPS spectra for Pt, C, and O after various etching times showed two prominent peaks at 71.1 eV and 74.5 eV that correspond to Pt⁰ in its metallic state. The two peaks were slightly stretched towards a higher level of binding energies, which were close to that of Pt oxides even though it did not find any oxides within the present Pt nanomembranes. The XPS spectrum of C Is showed four distinct peaks at approximately 282.9 eV, 284.8 eV, 286.2 eV, and 288.5 eV, which were attributed to C═C, C—C, C—O, and C═O, respectively. These chemical bonds were expected to be residuals from the decomposed PVA during the exfoliation process of 2D metals. The XPS spectrum of O Is exhibited two main peaks at approximately 532.2 cV and 533 eV, corresponding to C—O and C═O, respectively, which provided further evidence of decomposed PVA. No indications of Pt oxides were observed. However, the distributions of binding energy for Pt⁰ exhibited a skewness towards high energy values, resulting in the presence of fat tails. This observation could potentially be attributed to lattice distortion within the Pt nanocrystals.

FIG. 6B showed the relative concentrations of Pt, C, and O as a function of etching time, which demonstrated the chemical gradient in the Pt nanomembrane. The variation in composition with etching time was primarily attributed to the formation of a gradient nanostructure resulting from the reactions of metals and PVA. This phenomenon of a gradient nanostructure was also observed in gold nanomembranes fabricated using PSBEE.

Moreover, X-ray absorption spectroscopy (XAS) was performed on the Pt nanomembrane as well as two reference materials (e.g., Pt sheet and PtO₂) (FIG. 6C). Owing to the presence of metallic Pt, the Pt L₃ edge threshold energy and maximum energy for the X-ray absorption by the Pt nanomembrane appeared quite similar to those of Pt foil. However, a close inspection showed that the maximum absorption energy for the Pt nanomembrane is slightly higher than that of Pt foil (Pt⁰), but significantly smaller than that of PtO₂ (Pt^{IV}). This behavior implied that, despite the dominant metallic Pt bonding, there was a tendency to form a cationic environment around Pt. The Fourier transforms of the extended X-ray absorption fine structure (EXAFS) region yielded two prominent peaks at approximately 2.7 Å and 1.7 Å, corresponding to Pt—Pt and Pt—C/O coordination, respectively (FIG. 6D). Referring to FIGS. 6E-6F and Table 1, the EXAFS analysis revealed an average Pt coordination number of approximately 9.7 for our Pt nanomembrane, which was smaller than the conventional Pt coordination number (=12), indicative of a defected atomic structure in the Pt nanomembrane. FIG. 6G showed the curves of EXAFS χ(k) signals versus in k-space obtained for the Pt nanomembrane, PtO₂ and Pt foil, from which it could see that the Pt nanomembrane was similar to Pt foil. Aside from Pt—Pt bonds, a few Pt—C/O bonds were observed in the nanomembrane (FIG. 6H). Notably, similar results were also observed for the 28 nm thick Pt nanomembrane.

Table 1-EXAFS fitting parameters at the Pt L₃-edge for Pt foil and Pt nanomembrane (S₀²-0.839)

| Sample | Shell | CN^{a} | R(Å)^{b} | σ²(Å²)^{c} | ΔE₀(eV)^{d} | R factor |
|---|---|---|---|---|---|---|
| Pt foil | Pt—Pt | 12 | 2.762 ± 0.001 | 0.0048 ± 0.0001 | 7.4 ± 0.4 | 0.0017 |
| 19 nm Pt | Pt—C/O | 1.2 ± 0.2 | 2.097 ± 0.014 | 0.0092 ± 0.0050 | 9.4 ± 4.8 | 0.0074 |
| nanomembrane | Pt—Pt | 9.8 ± 0.3 | 2.772 ± 0.002 | 0.0061 ± 0.0009 | 9.5 ± 0.8 | |
| 28 nm Pt | Pt—C/O | 0.8 ± 0.2 | 2.101 ± 0.023 | 0.0100 ± 0.0026 | 4.1 ± 2.6 | 0.0032 |
| nanomembrane | Pt—Pt | 10.2 ± 0.4 | 2.779 ± 0.002 | 0.0052 ± 0.0006 | 10.6 ± 0.5 | |

^{a}CN, coordination number;
^{b}R, the distance to the neighboring atom;
^{c}σ², the Mean Square Relative Displacement (MSRD);
^{d}ΔE₀, inner potential correction;
R factor indicates the goodness of the fit.
S₀² was fixed to 0.839, according to the experimental EXAFS fit of Pt foil by fixing CN as the known crystallographic value

Due to limitations of the EXAFS technique, which did not allow for a direct distinction between Pt—C and Pt—O, measuring their coordination numbers proved to be challenging. For an indirect estimation, based on the observation in FIG. 6B, it was plausible that the coordination number of Pt—C was larger than that of Pt—O. Following this line of reasoning, it was anticipated that, as the thickness decreased, the coordination number of Pt—C/O would increase. This was supported by the EXAFS data of 19 nm and 28 nm Pt nanomembranes (Table 1). However, it was important to note that there was no clear trend, indicating that the Pt—C/O ratio significantly affected the HER performance.

### Example 5

### Configuration of Water Splitting Device

For fabrication of a water splitting device, a serpentine flow field using S-type titanium was used as the bipolar plate to separate the two electrodes and collect current. The PEM-WE electrolyser was assembled in the following sequence: end plate, sealing gasket, titanium current collector, 19 nm Pt nanomembrane on carbon cloth, proton-exchange membrane, IrO₂, titanium current collector, sealing gasket, and end plate (FIG. 1). The anode consisted of IrO₂ (99.9%, Macklin) with the mass loading of 0.43 mg cm⁻². The total geometric area of both the cathode and anode was 4.0 cm². The proton-exchange membrane (DuPont Nafion PFSA N117) was used to separate the cathode and anode compartments of the electrolyser. For the test, 0.5 M H₂SO₄ electrolyte was supplied to both sides of the electrolyser at a rate of 2.5 ml min⁻¹, controlled by a peristaltic pump. Cell voltages measured in a PEM electrolyzer without IR compensation were reported.

### Example 6

### Electrochemical Characterization in Acidic Electrolyte

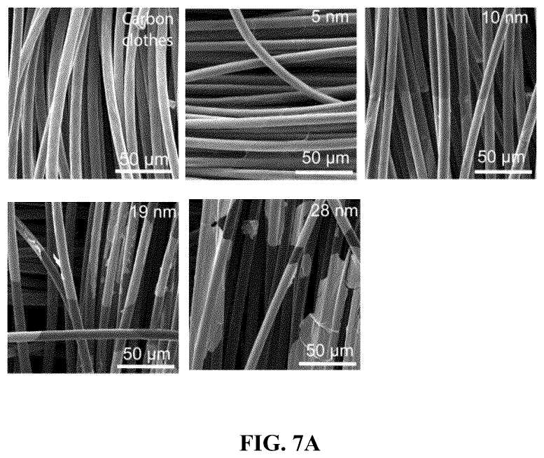

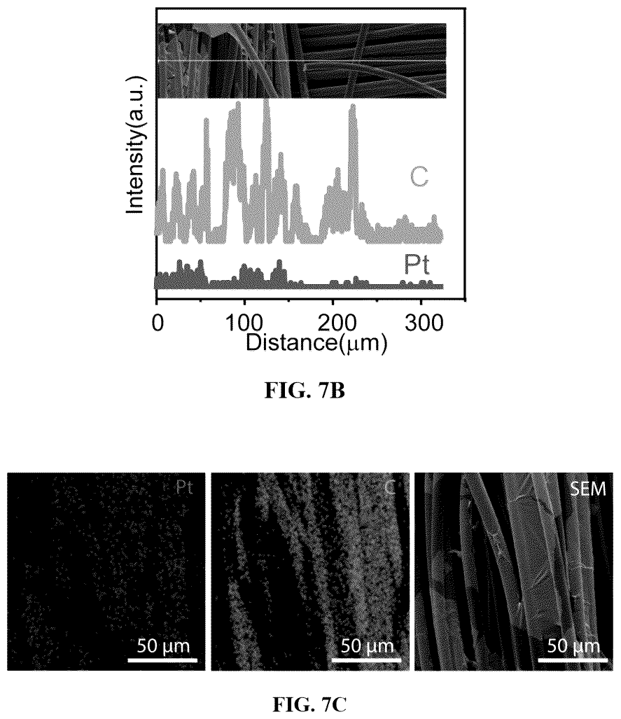

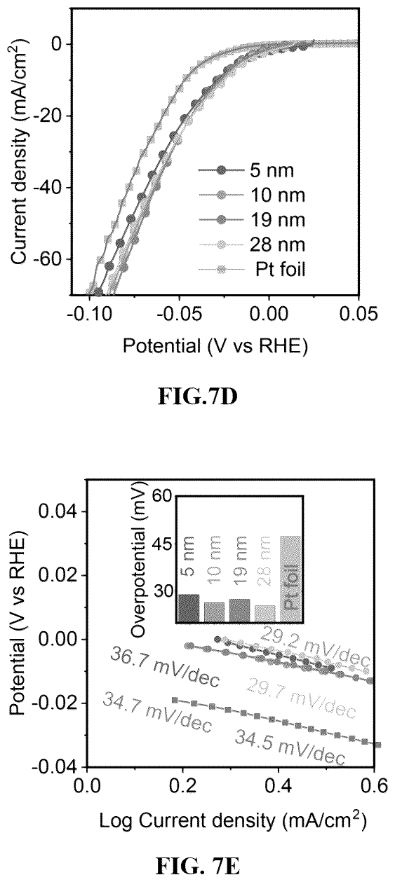

To prepare for evaluating their electrocatalytic properties, the Pt nanomembranes were transferred onto commercial carbon clothes for testing the HER. As shown in FIGS. 7A-7C, due to the Van der Waals force, the present nanomembranes were wrapped around individual carbon fibers in the carbon cloth after the nanomembrane transfer.

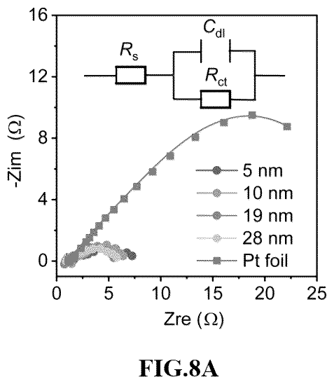

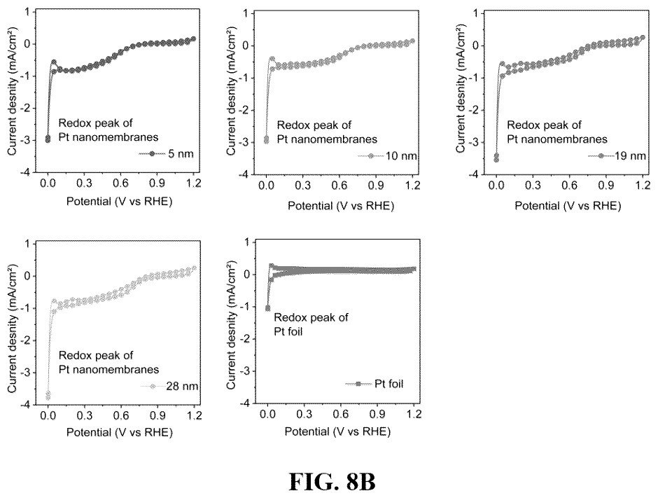

The electrochemical measurements were carried out on electrochemical workstation (Iviumstat Technology) using a conventional three-electrode cell in 0.5 M H₂SO₄ at room temperature. A graphite rod and a saturated calomel were used as the counter electrode and reference electrode, respectively. Acidic HER performance was shown in FIGS. 7D-7E. FIG. 7D demonstrated that the Pt nanomembranes, serving as electrocatalysts, exhibited significantly lower onset potentials compared to bulk Pt foil, indicating superior performance. From the polarization curves, η10 (i.e., the overpotential at 10 mA/cm²) and the Tafel slopes were extracted for the Pt nanomembranes with four different thicknesses (FIG. 7E). Notably, η10 of the Pt nanomembrane catalysts ranged from 26 mV to 29 mV, which was much smaller than that (=46 mV) of Pt foil catalysts. The Tafel slopes of the Pt nanomembrane catalyst ranged from 30 mV/dec to 37 mV/dec, suggesting a mechanism combining the Volmer-Tafel and Volmer-Heyrovsky reaction. Likewise, the Electrochemical Impedance Spectroscopy (EIS) and Cyclic Voltammetry (CV) results also showed that the HER performance of the nanomembranes was better than that of Pt foil (FIGS. 8A-8B).

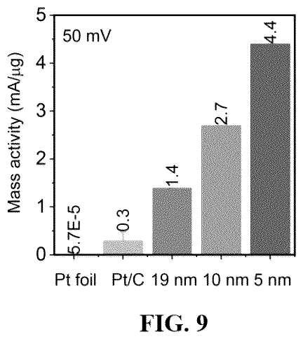

Moreover, since mass activity and turnover frequency (TOF) were another important metric to assess the potential scalability of metal based electrocatalysts, the catalyst loading of the Pt nanomembranes was measured by Inductively Coupled Plasma Optical Emission spectroscopy (ICP-OES) (FIG. 2), and their mass activities were calculated at the overpotential of 50 mV. As shown in FIG. 9, the mass activities of the Pt nanomembranes increased from 1.4 for 19 nm thick nanomembranes to 4.4 for 5 nm thick nanomembranes, which was about five orders of magnitude higher than that of bulk Pt foil (5.7×10⁻⁵) and one order of magnitude higher than that of commercial Pt/C (0.3).

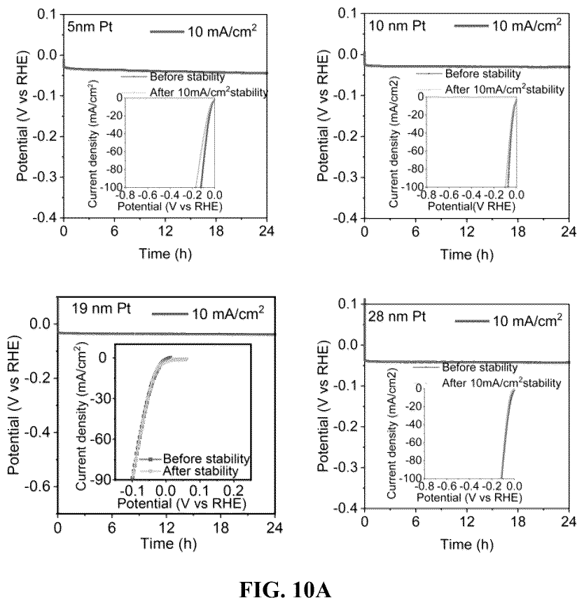

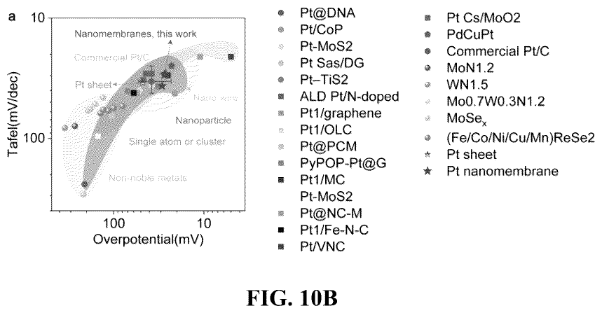

The catalytic efficiency of each Pt site was further quantified using TOF. As shown in Table 2, the TOF values at an overpotential of 100 mV ranged from 48.3 to 145.7 S⁻¹ for the Pt nanomembranes, significantly higher than those of most HER catalysts. Referring to FIG. 10A, the electrocatalytic stability of the Pt nanomembranes with varying thicknesses at a current density of 10 mA/cm² was also determined. Remarkably, these curves exhibited a high degree of overlap, indicating excellent stability.

In addition, the Pt nanomembranes was further compared with other electrocatalysts reported so far with regard to η10 and the Tafel slope. As shown in FIG. 10B, the Pt nanomembrane of the present invention exhibited excellent performance, ranking among the best.

TABLE 2
Summary of the TOF values and current densities at the
overpotential of 100 mV between the Pt nanomembrane of the
present invention and other Pt-based catalysts
in 0.5M H₂SO₄

| | Current density | | |
|---|---|---|---|
| | at 100 mV | TOF | |
| Catalysts | (mA/cm²) | 100 mV(s⁻¹) | Note |
| PtGa | 500 | 17.1 | |
| Pt—Ru/CNT | 265 | 25.1 | |
| Pt1 SAC-VNGNMA | 88 | 4.0 | |
| Pt1/OLC | 56.5 | 40.8 | |
| Pt—SAs/WS₂ | 54 | 131.7 | |
| Pt₂W/WO₃/RGO | 44 | 2 | |
| Pt1/NMHCS | 40 | 4.5 | |
| PtRu@RFCS-6 h | 32 | 4.0 | |
| Pt—SAs/MoS₂ | 24 | 47.3 | |
| Pt@PCM | 11 | 3.2 | |
| 5 nm Pt nanomembrane | 74.7 | 145.7 | This work |
| 10 nm Pt nanomembrane | 83.8 | 90.2 | This work |
| 19 nm Pt nanomembrane | 89.7 | 48.3 | This work |

Additionally, the morphology of the Pt nanomembrane and the Pt concentration in the electrolyte were examined after the stability test. As shown in FIG. 11, the Pt nanomembrane still adhered to the carbon fibers after the long-term test, and the Pt ion concentration in the solution was negligible (2.2 μg/L).

Extensive XPS analysis was conducted following stability tests lasting 24 hours at a current density of 10 mA/cm². The result showed two prominent peaks at 71.1 eV and 74.5 eV, which corresponded to the metallic state (Pt⁰) of Pt, regardless of the etching time. Furthermore, the O Is analysis revealed no indications of metal oxides or any peaks within the 529-530 eV range, providing further evidence of the excellent electrochemical stability of the Pt nanomembranes.

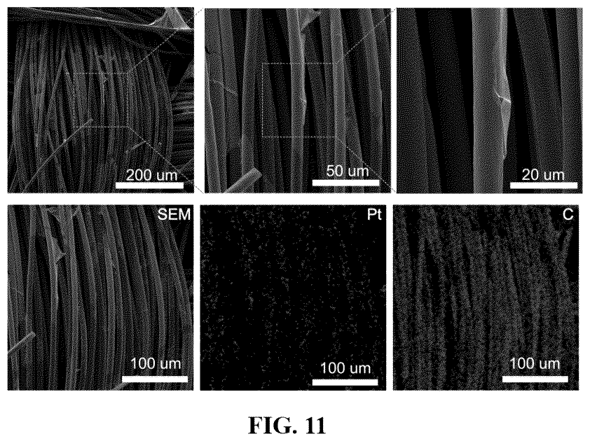

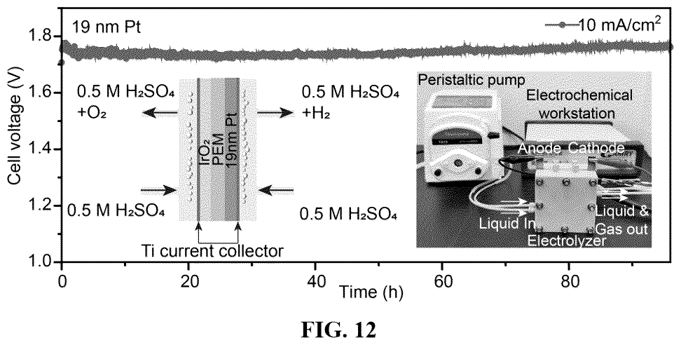

It was observed that significant skewness appeared in the binding energy distributions for Pt⁰ towards high energy values, suggesting possible further distortion of the Pt nanocrystals after the stability tests. The SEM results revealed that most Pt nanomembrane remained adhered to the carbon fibers, with some micro-scale cracks. Note that with the decrease of thickness, Pt nanomembrane (5 nm) tended to fracture in a brittle mode, making it difficult for transfer without extensive premature failure. As a demonstration for future industrial applications, 19 nm Pt nanomembranes were chosen as the cathodic HER catalyst, and commercial IrO₂ was selected as the anodic OER catalyst in a PEM-WE device (FIG. 12) due to the ease of transferring the 19 nm Pt nanomembrane. At the current density of 10 mA/cm², the voltage remained to be a constant of approximately 1.72 V without IR compensation, and the overpotential amplification was negligible even after 100 hours of testing.

### Example 7

### Mechanism

It has been demonstrated that elastic strain can enhance electrochemical catalytic reactions by modifying the binding energy of intermediates through changes in the electronic state at the Fermi level. However, current investigations have primarily focused on the effects of uniform strains applied to ideal crystals. In contrast, the Pt nanomembrane was composed of highly distorted nanocrystals with heterogeneous elastic strains.

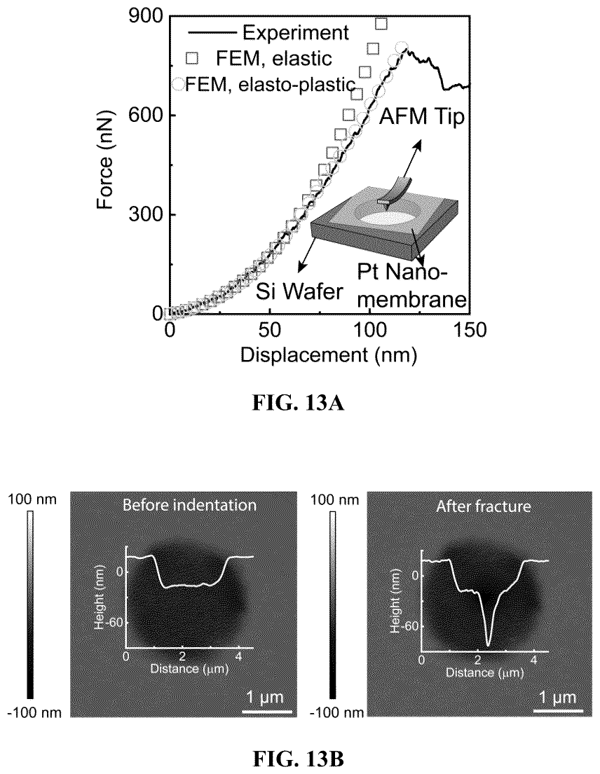

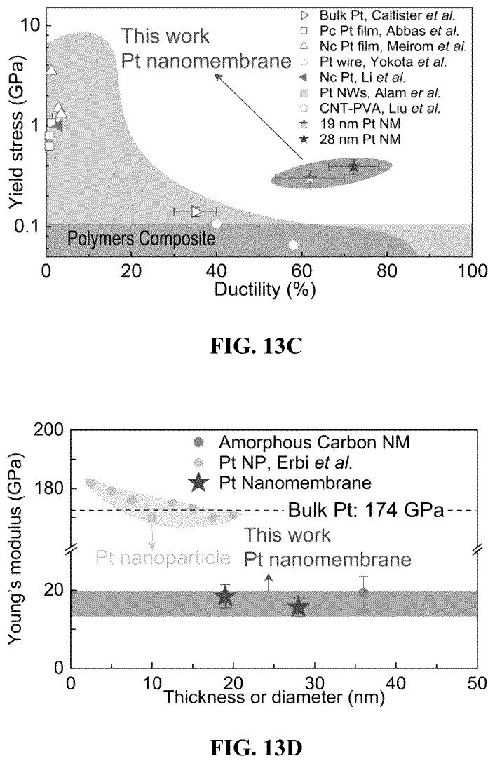

Through atomic force microscopy (AFM) indentation, the clastic modulus of the Pt nanomembrane was found to be as low as 16±2 GPa, approximately 9% of the elastic modulus (179 GPa) of Pt nanocrystals with a size of 5 nm (FIGS. 13A-13D). A similar phenomenon of modulus reduction induced by lattice distortion was also observed in high entropy alloys⁶.

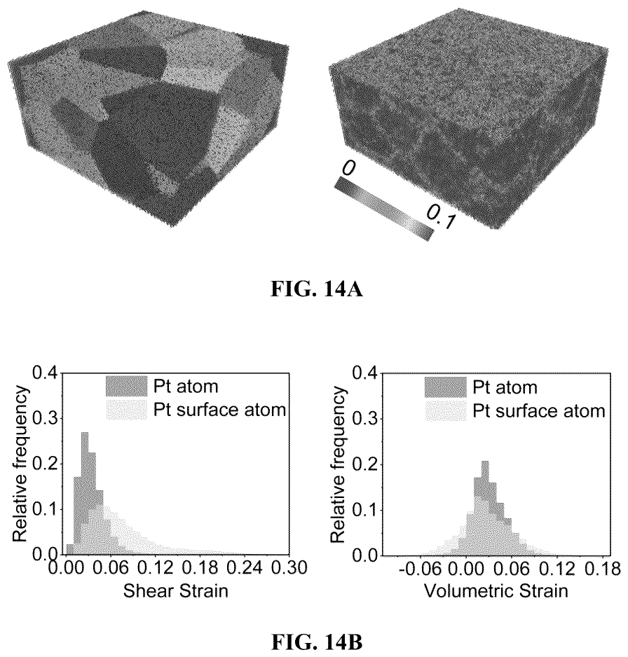

To understand the origin of such heterogeneous strains, large-scale molecular dynamics (MD) simulations were performed on Pt nanocrystals with a significant amount of substitutional C atoms. FIG. 14A illustrated atomic configurations of Pt nanocrystalline with substitutional C atoms. FIG. 14B showed the distribution of Shear Strain and Volumetric Strain via Pt nanocrystalline with/without surface atoms. The results unveiled a heterogeneous distribution of both shear and normal strains across the surface of the nanocrystals. These strains were induced by excessive crystalline defects, specifically vacancies, present on the surface and within nanocrystalline boundaries (Table 1). Consequently, the observed surface strain distributions similar to the experimental results depicted in FIGS. 4B-4C.

Extensive density functional theory (DFT) simulations were performed to investigate heterogeneous strains on the surface adsorption behavior of distorted or defected nanocrystals.

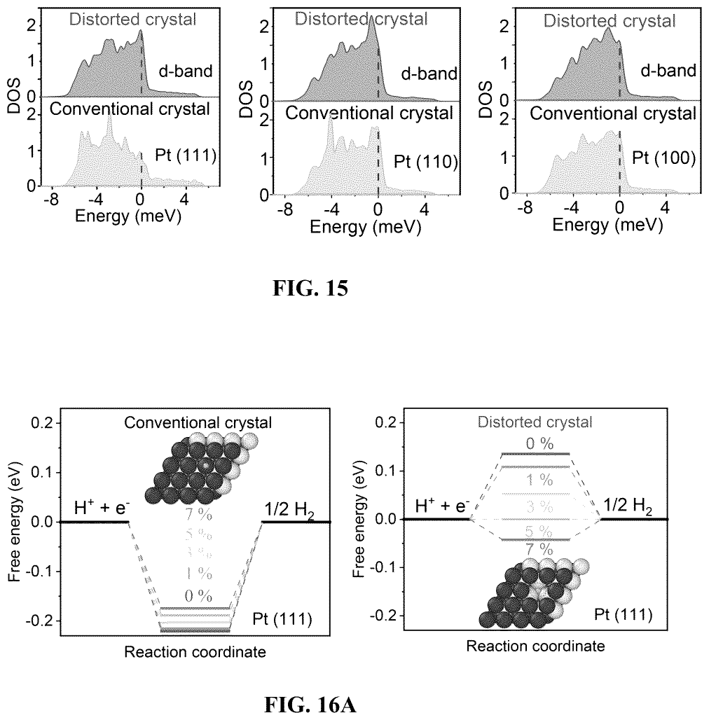

The effect of heterogeneous strain was systematically studied. The reference model “ideal Pt nanocrystal” was subjected to a uniform strain from 0 to 7% in the (111), (100) and (110) orientations. Another atomic model was built to mimic lattice distortion with heterogeneous strains by inserting vacancies on the surface of Pt nanocrystals. The defected Pt nanocrystals were also subjected to a tensile strain from 0 to 7% along the (111), (100) and (110) orientations. As shown in FIG. 15, the simulations revealed that heterogeneous strains in distorted nanocrystals resulted in an upshift of d-band centers, promoting H adsorption regardless of the crystal orientation.

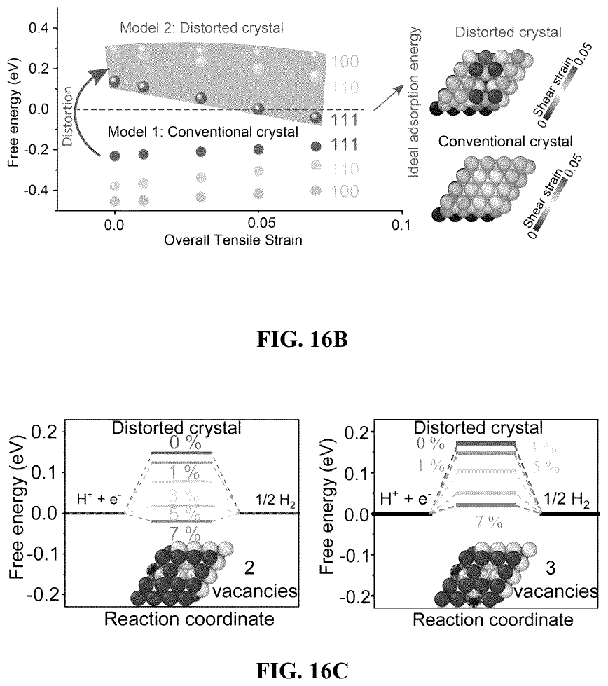

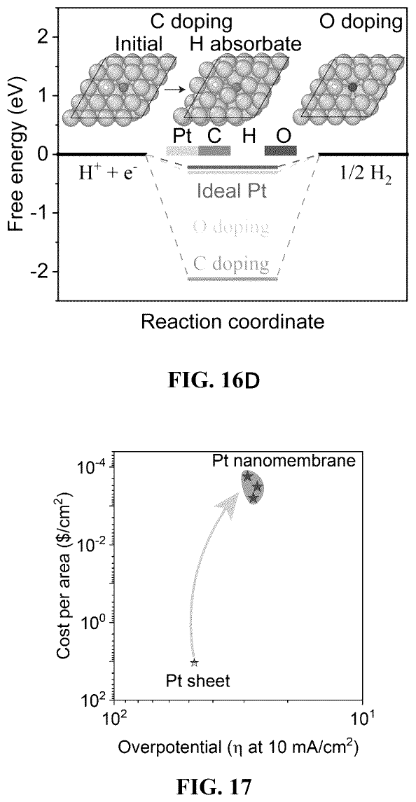

The change in the Gibbs free energy ΔG_{H*} for hydrogen adsorption on different surfaces was then calculated. As seen in FIGS. 16A-16B, ΔG_{H*} remained negative for all conventional Pt nanocrystals and increased with uniform strain. In sharp contrast, ΔG_{H*} turned positive when the Pt nanocrystals became severely distorted. As the distorted Pt nanocrystals were strained, ΔG_{H*} reduced progressively and even reached the zero energy at a strain of 5% on the distorted (111) surface, which was ideal for hydrogen production, but was never reached by simply straining conventional Pt within the Lindeman strain limit (about 10%), above which a crystal becomes unstable. These important findings indicated that lattice distortion, manifested as heterogeneous elastic strains (inset of FIG. 16B), could regulate the hydrogen adsorption energy on the Pt surface over a much wider range than conventional elastic strain engineering. This led to a greater tunability of the HER performance. These computational results rationalized that distorted Pt nanocrystals were more efficient than conventional Pt nanocrystals in catalyzing water splitting. FIG. 16C showed free energy calculation of distorted crystal with different vacancies.

In the present invention, heteroatom doping, such as carbon doping or oxygen doping, was also considered. Initially, an atomic model representing an ideal or non-distorted Pt nanocrystal was constructed as a reference. However, the results revealed that doping of carbon or oxygen did not have a beneficial effect on the HER performance (FIG. 16D).

### Cost Per Area of the Pt Nanomembranes

As shown in FIG. 17, it was evident that the Pt nanomembranes (approximately 10³ to 10⁻⁴ $/cm²) were several orders of magnitude cheaper than Pt foil (approximately 10 $/cm²).

In summary, the present invention provides ultra-efficient and affordable Pt nanomembrane electrocatalysts for the HER, exhibiting excellent electrochemical stability through PSBEE. By inducing lattice distortion and heterogeneous strain in the Pt nanomembrane, enhanced HER performance is achieved. Furthermore, due to the ultra-thin nature of the Pt nanomembrane, it is highly cost-effective, even comparable to non-noble metal catalysts. Since PSBEE can be employed to fabricate various metallic and ceramic nanomembranes regardless of their chemical compositions, this approach holds promise for developing low-dimensional electrocatalysts for numerous other critical electrochemical reactions.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

### INDUSTRIAL APPLICABILITY

The present invention demonstrates that the PSBEE method is a simple, scalable process capable of producing large quantities of metal-based nanomembranes (such as Au, high entropy alloy, and Pt) at a low cost. This makes it promising for the synthesis of next-generation low-dimensional electrocatalysts. Most importantly, unlike other 2D and conventional electrocatalysts, the Pt nanomembranes synthesized via PSBEE in the present invention possess a unique nanostructure composed of severely distorted nanocrystals. The abundance of atomic-scale defects (i.e., vacancies) caused by lattice distortion, and the resulting heterogeneous strains, work synergistically to enhance the HER catalytic performance of the Pt nanomembranes. This enables them to surpass commercial and many other conventional Pt electrocatalysts.

The Pt nanomembranes offer excellent conductivity, catalytic activity, biocompatibility, optical properties, and mechanical performance. These characteristics provide wide-ranging application prospects in fields such as energy, catalysis, biomedicine, and nanotechnology. Examples of applications include, but are not limited to: oxygen reduction reaction (ORR) in fuel cells, HER in water electrolysis, oxygen evolution reaction (OER) in metal-air batteries, etc.

### Definitions

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

As used herein and not otherwise defined, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

“Atomic percent” refers to the percentage of atoms of each element in a composition relative to the total number of atoms. The atomic percent of each element in the composition should add up to 100%.

“η10” represents the catalytic efficiency of the 10th electrode, typically used to describe the efficiency of a electrocatalyst in catalyzing the hydrogen evolution reaction.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

### REFERENCES: THE DISCLOSURES OF THE FOLLOWING REFERENCES ARE INCORPORATED BY REFERENCE

1. J. N. Tiwari, S. Sultan, C. W. Myung, T. Yoon, N. Li, et al., Multicomponent electrocatalyst with ultralow Pt loading and high hydrogen evolution activity. Nat. Energy 3, 773-782 (2018).
2. D. Liu, X. Li, S. Chen, H. Yan, C. Wang, et al., Atomically dispersed platinum supported on curved carbon supports for efficient electrocatalytic hydrogen evolution. Nat. Energy 4, 512-518 (2019).
3. T. Wang, M. Park, Q. He, Z. Ding, Q. Yu, et al., Low-Cost Scalable Production of Freestanding Two-Dimensional Metallic Nanosheets by Polymer Surface Buckling Enabled Exfoliation. Cell Reports Phys. Sci. 1, 100235 (2020).
4. T. Wang, Z. Zhang, M. Park, Q. Yu, and Y. Yang, Etching-Free Ultrafast Fabrication of Self-Rolled Metallic Nanosheets with Controllable Twisting. Nano Lett. 21, 7159-7165 (2021).
5. T. Wang, Q. He, J. Zhang, Z. Ding, F. Li, et al., The controlled large-area synthesis of two dimensional metals. Mater. Today 36, 30-39 (2020).
6. Q. F. He, J. G. Wang, H. A. Chen, Z. Y. Ding, Z. Q. Zhou, et al., A highly distorted ultraelastic chemically complex Elinvar alloy. Nature 602, 251-257 (2022).

What is claimed is:

1. A large-area and freestanding metal-based nanomembrane electrocatalyst for sustainable hydrogen production, comprising one or more metal nanocrystals with lattice expansion, wherein the one or more metal nanocrystals comprise a highly distorted and heterogeneous nanostructure, the one or more metal nanocrystals are joined together through nanosized amorphous carbon interphases, and lattice distortion and heterogeneous strain in the large-area and freestanding metal-based nanomembrane electrocatalyst are induced to achieve enhanced hydrogen evolution reaction performance.

2. The large-area and freestanding metal-based nanomembrane electrocatalyst of claim 1, wherein the large-area and freestanding metal-based nanomembrane demonstrates a heterogeneous distribution of local electric conductivity, characterized by highly conductive nano-domains surrounded by less conductive regions.

3. The large-area and freestanding metal-based nanomembrane electrocatalyst of claim 1, wherein the highly distorted and heterogeneous nanostructure comprises FCC nanocrystals and amorphous regions between clusters of FCC nanocrystals.

4. The large-area and freestanding metal-based nanomembrane electrocatalyst of claim 1, wherein the metal is selected from gold, platinum, silver, titanium, palladium, ruthenium, iridium, or other high entropy alloys, or a combination thereof.

5. The large-area and freestanding metal-based nanomembrane electrocatalyst of claim 1, wherein the large-area and freestanding metal-based nanomembrane electrocatalyst comprises 20-80 at % of platinum, 10-50 at % of carbon, and 1-30 at % of oxygen.

6. The large-area and freestanding metal-based nanomembrane electrocatalyst of claim 1, wherein the large-area and freestanding metal-based nanomembrane electrocatalyst has a thickness ranging from 1 nm to 30 nm.

7. The large-area and freestanding metal-based nanomembrane electrocatalyst of claim 1, wherein the one or more metal nanocrystals have an average size between 1 nm and 10 nm.

8. The large-area and freestanding metal-based nanomembrane electrocatalyst of claim 1, wherein the large-area and freestanding metal-based nanomembrane electrocatalyst is binder-free.

9. The large-area and freestanding metal-based nanomembrane electrocatalyst of claim 1, wherein the large-area and freestanding metal-based nanomembrane electrocatalyst synthesized via polymer surface buckling-enabled exfoliation.

10. The large-area and freestanding metal-based nanomembrane electrocatalyst of claim 9, wherein the polymer surface buckling-enabled exfoliation comprises the following steps: using a polymer layer on a substrate as a scaffold to support a metal film; inducing controlled buckling on the polymer surface; and exfoliating the metal film to obtain the large-area and freestanding metal-based nanomembrane electrocatalyst.

11. The large-area and freestanding metal-based nanomembrane electrocatalyst of claim 10, wherein the substrate comprises glass plate, or silicon wafer.

12. The large-area and freestanding metal-based nanomembrane electrocatalyst of claim 10, wherein the polymer comprises polyvinyl alcohol.

13. The large-area and freestanding metal-based nanomembrane electrocatalyst of claim 1, wherein the large-area and freestanding metal-based nanomembrane electrocatalyst exhibits an η10 value of less than 30 mV.

14. The large-area and freestanding metal-based nanomembrane electrocatalyst of claim 1, wherein the large-area and freestanding metal-based nanomembrane electrocatalyst exhibits Tafel slopes ranging from 30 mV/dec to 37 mV/dec.

15. A water splitting device comprising the large-area and freestanding metal-based nanomembrane electrocatalyst of claim 1.

16. A proton exchange membrane fuel cell comprising the large-area and freestanding metal-based nanomembrane electrocatalyst of claim 1.
